(19) United States
(12) Patent Application Publication
(10) Pub. No.: US 2020/0307648 A1
(43) Pub. Date: Oct. 1, 2020

(54) PARKING LOT MANAGEMENT DEVICE, PARKING LOT MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/824,732

(22) Filed: Mar. 20, 2020

(30) Foreign Application Priority Data
Mar. 29, 2019 (JP) 2019-068978

(51) Int. Cl. B60W 60/00; G08G 1/01; G06Q 50/30; G06Q 10/02

(52) U.S. Cl. CPC B60W 60/00253; G06Q 10/02; G06Q 50/30; G08G 1/0133

(57) ABSTRACT

A parking lot management device includes a platform selector configured to refer to information associated with a parking lot having a plurality of platforms and select one or more platforms from among the plurality of platforms in response to a leaving request for requesting movement of a vehicle parked in the parking lot from a parking position of the vehicle to the platform.

### CROSS-REFERENCE TO RELATED APPLICATION

Priority is claimed on Japanese Patent Application No. 2019-068978, filed Mar. 29, 2019, the content of which is incorporated herein by reference.

### BACKGROUND OF THE INVENTION

### Field of the Invention

The present invention relates to a parking lot management device, a parking lot management method, and a storage medium.

### Description of Related Art

Technology related to a vehicle guiding system for guiding vehicles to a parking lot gate on the basis of information of traffic congestion around a parking lot in order to efficiently, rapidly, and safely guide vehicles to a parking lot of a facility having a vast parking lot has been disclosed (for example, see Japanese Unexamined Patent Application, First Publication No. 2004-252816). Technology related to an elevator user guiding system for collectively guiding users for each destination floor before they get on and off an elevator to reduce the operation time of the elevator in a building where a plurality of elevators are installed has been disclosed (for example, see Japanese Unexamined Patent Application, First Publication No. 2018-158793).

Incidentally, in recent years, research has been conducted on automatedly controlling vehicles. Also, research is being conducted on the implementation of automated valet parking using the above technology. Therefore, the application of a concept of technology disclosed in Japanese Unexamined Patent Application, First Publication No. 2004-252816 and Japanese Unexamined Patent Application, First Publication No. 2018-158793 as a system for recommending any platform and guiding a vehicle to the recommended platform in an automated valet parking system in which a plurality of platforms are scattered in a vast parking lot is conceived.

However, the technology disclosed in Japanese Unexamined Patent Application, First Publication No. 2004-252816 is technology for use in a nearby road until a vehicle enters a parking lot. The technology disclosed in Japanese Unexamined Patent Application, First Publication No. 2018-158793 is technology for use in an elevator installed in a building or the like. For this reason, in order to apply the concept of the technology disclosed in Japanese Unexamined Patent Application, First Publication No. 2004-252816 or Japanese Unexamined Patent Application, First Publication No. 2018-158793 to a system for guiding a vehicle to a recommended platform in automated valet parking, it is necessary to take into account specific situations of the parking lot such as a direction in which the vehicle moves after leaving the parking lot, a period of time required for a user (an occupant) of the vehicle to get into and out of the vehicle at the platform, and a congestion situation within the parking lot. Thus, it is not possible to implement a smooth operation of the parking lot.

### SUMMARY OF THE INVENTION

The present invention has been made on the basis of the recognition of the above-described problems and an objective of the present invention is to provide a parking lot management device, a parking lot management method, and a storage medium capable of causing a vehicle to smoothly leave a parking lot.

A parking lot management device, a parking lot management method, and a storage medium according to the present invention adopt the following configurations.

(1): According to an aspect of the present invention, there is provided a parking lot management device including: a platform selector configured to refer to information associated with a parking lot having a plurality of platforms and select one or more platforms from among the plurality of platforms in response to a leaving request for requesting movement of a vehicle parked in the parking lot from a parking position of the vehicle to the platform.

(2): In the above-described aspect (1), the parking lot management device further includes a notifier configured to receive information of a traveling direction of a user of the vehicle sending the leaving request after the vehicle leaves the parking lot and notify the user of information of the platform selected by the platform selector.

(3): In the above-described aspect (2), the parking lot management device further includes a guider configured to guide the vehicle for which the leaving request has been sent to the platform selected by the platform selector.

(4): In the above-described aspect (1), the information associated with the parking lot includes some or all of a degree of congestion for each of the plurality of platforms, the parking position, and the traveling direction after the vehicle leaves the parking lot.

(5): In the above-described aspect (1), the platform selector is configured to derive a score for each of the plurality of platforms on the basis of the information associated with the parking lot and is configured to select one or more platforms from the plurality of platforms on the basis of derived scores.

(6): In the above-described aspect (1), the information associated with the parking lot includes the traveling direction after the vehicle leaves the parking lot, and the platform selector is configured to preferentially select an appropriate platform near a gate in the traveling direction.

(7): In the above-described aspect (1), the information associated with the parking lot includes a congestion situation of a nearby road around the parking lot, and the platform selector is configured to select one or more platforms from the plurality of platforms on the basis of a congestion situation of a road to which the vehicle moves after the vehicle leaves the parking lot.

(8): In the above-described aspect (1), the platform selector is configured to preferentially select a platform at which the vehicle is able to arrive without passing through a congested area within the parking lot.

(9): In the above-described aspect (8), the platform selector sets a least congested moving route among a plurality of moving routes from the parking position to the platform as a moving route toward the platform.

(10): In the above-described aspect (1), the platform selector is configured to preferentially select a platform where a large number of users of vehicles parked in the parking lot are able to be accommodated.

(11): In the above-described aspect (3), the guider further comprises a remote controller configured to cause the vehicle within the parking lot to automatedly travel according to a remote operation, and, the remote controller is configured to cause the vehicle which leaves the parking lot to automatedly travel to the gate according to a remote operation in a case where a distance of a predetermined reference value or more is between the platform selected by the platform selector and a gate for the vehicle.

(12): In the above-described aspect (3), the guider is configured to cause a vehicle having a low automated driving level to be parked in a parking area near a specific platform.

(13): In the above-described aspect (12), the specific platform is a platform having a lower degree of difficulty of traveling than other platforms in a case where the vehicle moves around.

(14): According to an aspect of the present invention, there is provided a parking lot management method using a computer including: referring to information associated with a parking lot having a plurality of platforms and selecting one or more platforms from among the plurality of platforms in response to a leaving request for requesting movement of a vehicle parked in the parking lot from a parking position of the vehicle to the platform.

(15): According to an aspect of the present invention, there is provided a computer-readable non-transitory storage medium storing a program for causing a computer of a parking lot management device to: refer to information associated with a parking lot having a plurality of platforms and select one or more platforms from among the plurality of platforms in response to a leaving request for requesting movement of a vehicle parked in the parking lot from a parking position of the vehicle to the platform.

According to the above-described aspects (1) to (15), it is possible to cause a vehicle to smoothly leave a parking lot.

### BRIEF DESCRIPTION OF THE DRAWINGS

FIG. 1 is a configuration diagram of a vehicle system including a vehicle control device mounted on a vehicle using a parking lot to which a parking lot management device according to a first embodiment is applied.

FIG. 2 is a functional configuration diagram of a first controller and a second controller.

FIG. 3 is a diagram schematically showing a scene in which an autonomous parking event is executed.

FIG. 4 is a diagram showing an example of a configuration of a parking lot management device according to the first embodiment.

FIG. 5 is a flowchart showing an example of a flow of a platform selection process to be executed by a platform selector according to the first embodiment.

FIG. 6 is a diagram showing an example of a parking space state table and a congestion score derived by a score deriver in a parking lot management device according to a second embodiment.

FIG. 7 is a flowchart showing an example of a flow of a platform selection process to be executed by a platform selector according to the second embodiment.

FIG. 8 is a diagram showing a scene schematically showing a first example of a moving route selected in a platform selection process of the platform selector.

FIG. 9 is a diagram showing a scene schematically showing a second example of the moving route selected in the platform selection process of the platform selector.

FIG. 10 is a diagram showing a scene schematically showing a third example of the moving route selected in the platform selection process of the platform selector.

FIG. 11 is a diagram showing an example of a hardware configuration of a controller according to the embodiment.

### DETAILED DESCRIPTION OF THE INVENTION

Embodiments of a parking lot management device, a parking lot management method, and a storage medium of the present invention will be described below with reference to the drawings. Although a case in which left-hand traffic regulations are applied will be described, it is only necessary to reverse the left and right when right-hand traffic regulations are applied.

### First Embodiment

### [Overall Configuration Example of Vehicle System 1]

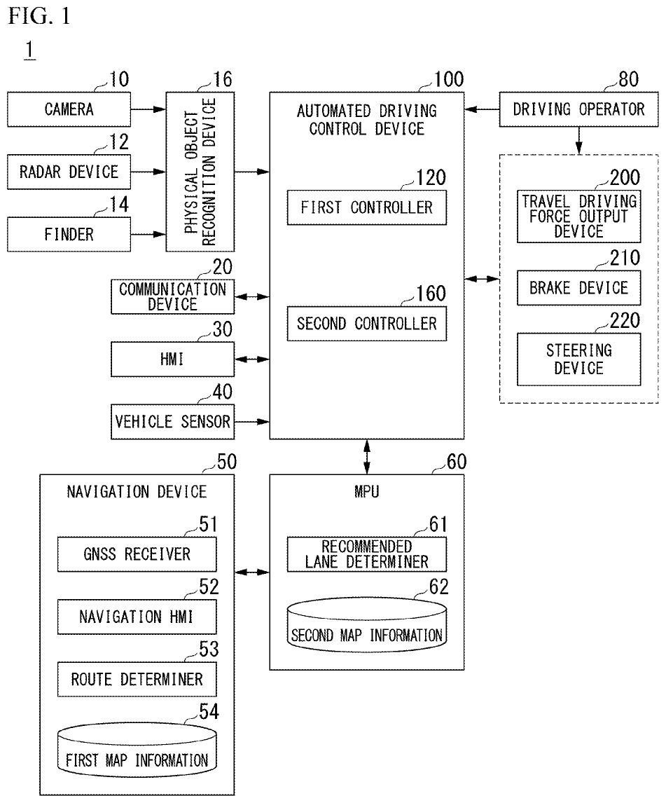

FIG. 1 is a configuration diagram of a vehicle system 1 including a vehicle control device mounted on a vehicle using a parking lot to which a parking lot management device according to a first embodiment is applied. A vehicle equipped with the vehicle system 1 is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example, a part of the configuration may be omitted, and another configuration may be further added.

For example, the camera 10 is a digital camera using a solid-state imaging element such as a charge coupled device (CCD) or a complementary metal oxide semiconductor (CMOS). The camera 10 is attached to any position on the vehicle (hereinafter, a vehicle M) on which the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position (a distance to and a direction) of a physical object by detecting radio waves (reflected waves) reflected by the physical object. The radar device 12 is attached to any position on the vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the vehicle M and measures scattered light. The finder 14 detects a distance to an object on the basis of time from light emission to light reception. The radiated light is, for example, pulsed laser light. The finder 14 is attached to any position on the vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

The communication device 20 communicates with a terminal (hereinafter, a user terminal T) used by a user U of the vehicle M and another vehicle or a parking lot management device (to be described below) present in the vicinity of the vehicle M or various types of server devices using, for example, a cellular network or a Wi-Fi network, Bluetooth (registered trademark), dedicated short range communication (DSRC), or the like.

The HMI 30 presents various types of information to the user of the vehicle M and receives an input operation of the user. The HMI 30 includes various types of display devices, a speaker, a buzzer, a touch panel, a switch, keys, and the like.

The vehicle sensor 40 includes a vehicle speed sensor configured to detect the speed of the vehicle M, an acceleration sensor configured to detect acceleration, a yaw rate sensor configured to detect an angular speed around a vertical axis, a direction sensor configured to detect a direction of the vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of a signal received from a GNSS satellite. The position of the vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the vehicle M identified by the GNSS receiver 51 (or any input position) to a destination input by the user using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal (for example, the user terminal T) possessed by the user. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage device such as an HDD or a flash memory.

The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels in from the left. The recommended lane determiner 61 determines the recommended lane so that the vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/zip code), facility information, telephone number information, and the like. The second map information 62 may be updated at any time when the communication device 20 communicates with another device.

For example, the driving operator 80 includes an accelerator pedal, a brake pedal, a shift lever, a steering wheel, a steering wheel variant, a joystick, and other operation elements. A sensor configured to detect an amount of operation or the presence or absence of an operation is attached to the driving operator 80, and a detection result thereof is output to the automated driving control device 100 or some or all of the travel driving force output device 200, the brake device 210, and the steering device 220.

The automated driving control device 100 includes, for example, a first controller 120 and a second controller 160. The first controller 120 and the second controller 160 are implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or a flash memory of the automated driving control device 100 (a storage device including a non-transitory storage medium) or may be installed in the HDD or the flash memory of the automated driving control device 100 when the program is stored in a removable storage medium such as a DVD or a CD-ROM and the storage medium (the non-transitory storage medium) is mounted in a drive device.

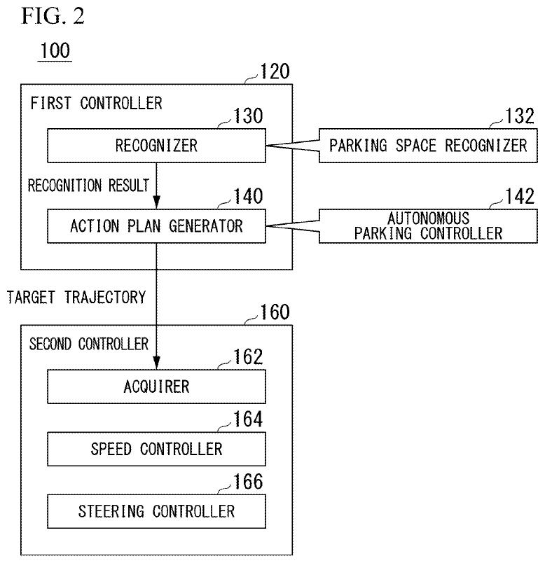

FIG. 2 is a functional configuration diagram of the first controller 120 and the second controller 160. The first controller 120 includes, for example, a recognizer 130 and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognizer 130 recognizes a state such as a position, velocity, or acceleration of a physical object present in the vicinity of the vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane in which the vehicle M is traveling (a travel lane). For example, the recognizer 130 recognizes the travel lane by comparing a pattern of a road dividing line (for example, an arrangement of solid lines and broken lines) obtained from the second map information 62 with a pattern of road dividing lines in the vicinity of the vehicle M recognized from an image captured by the camera 10. The recognizer 130 may recognize a travel lane by recognizing a traveling path boundary (a road boundary) including a road dividing line, a road shoulder, a curb stone, a median strip, a guardrail, or the like as well as a road dividing line. In this recognition, a position of the vehicle M acquired from the navigation device 50 or a processing result of the INS may be added. The recognizer 130 recognizes a temporary stop line, an obstacle, red traffic light, a toll gate, and other road events.

When the travel lane is recognized, the recognizer 130 recognizes a position or orientation of the vehicle M with respect to the travel lane. For example, the recognizer 130 may recognize a gap of a reference point of the vehicle M from the center of the lane and an angle formed with respect to a line connecting the center of the lane in the travel direction of the vehicle M as a relative position and orientation of the vehicle M related to the travel lane. Alternatively, the recognizer 130 may recognize a position of the reference point of the vehicle M related to one side end portion (a road dividing line or a road boundary) of the travel lane or the like as a relative position of the vehicle M related to the travel lane.

The recognizer 130 includes a parking space recognizer 132 to be activated in an autonomous parking event to be described below. Details of the function of the parking space recognizer 132 will be described below.

The action plan generator 140 generates a future target trajectory along which the vehicle M automatedly travels so that the vehicle M can generally travel in the recommended lane determined by the recommended lane determiner 61 and further cope with a surrounding situation of the vehicle M. For example, the target trajectory includes a speed element. For example, the target trajectory is represented by sequentially arranging points (trajectory points) at which the vehicle M is required to arrive. The trajectory point is a point where the vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the vehicle M is required to arrive at the sampling time for each predetermined sampling time. In this case, information about the target speed or the target acceleration is represented by an interval between the trajectory points.

The action plan generator 140 may set an automated driving event when the target trajectory is generated. The automated driving event includes a constant-speed traveling event, a low-speed following event, a lane change event, a branching event, a merging event, a takeover event, an autonomous parking event in which a vehicle is parked according to unmanned traveling in valet parking or the like, and the like. The action plan generator 140 includes an autonomous parking controller 142 to be activated when the autonomous parking event is executed. Details of the function of the autonomous parking controller 142 will be described below.

The second controller 160 controls the travel driving force output device 200, the brake device 210, and the steering device 220 so that the vehicle M passes along the target trajectory generated by the action plan generator 140 at a scheduled time.

Returning to FIG. 2, the second controller 160 includes, for example, an acquirer 162, a speed controller 164, and a steering controller 166. The acquirer 162 acquires information of a target trajectory (a trajectory point) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the vehicle M and feedback control based on a deviation from the target trajectory in combination.

The travel driving force output device 200 outputs a travel driving force (torque) for driving the vehicle to the drive wheels. The travel driving force output device 200 includes, for example, a combination of an internal combustion engine, an electric motor, a transmission, and the like, and an electronic control unit (ECU) that controls these components. The ECU controls the above-described components in accordance with information input from the second controller 160 or information input from the driving operator 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operator 80 so that brake torque according to a braking operation is output to each wheel. The brake device 210 may include a mechanism configured to transfer the hydraulic pressure generated by an operation of the brake pedal included in the driving operator 80 to the cylinder via a master cylinder as a backup. Also, the brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor to change the direction of the steerable wheels in accordance with the information input from the second controller 160 or the information input from the driving operator 80.

### [Autonomous Parking Event-Time of Entering]

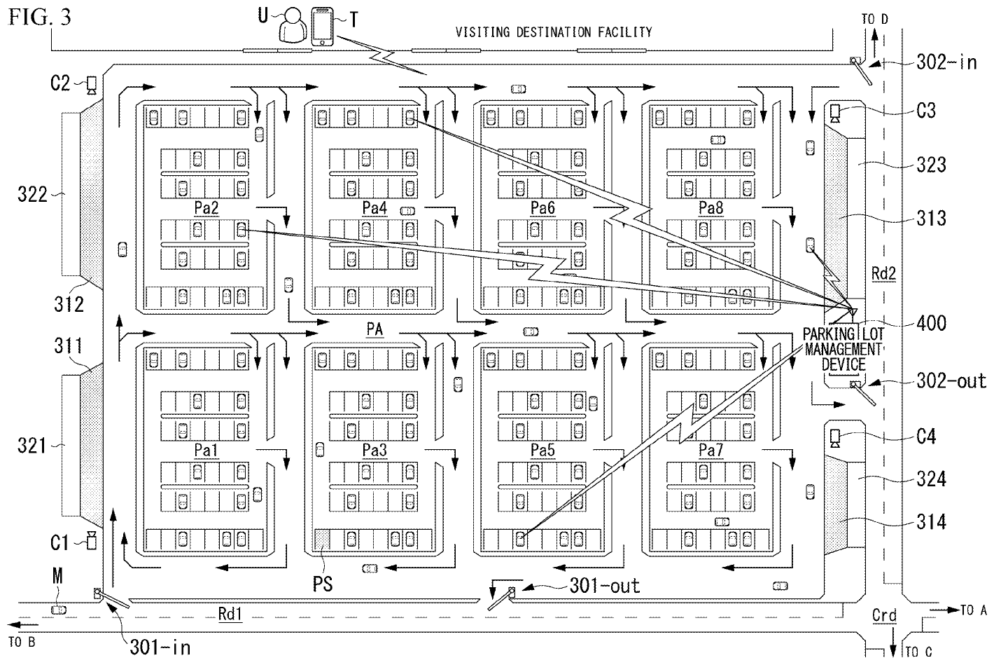

For example, the autonomous parking controller 142 causes the vehicle M to be parked within the parking space on the basis of information acquired from the parking lot management device 400 by the communication device 20. FIG. 3 is a diagram schematically showing a scene in which an autonomous parking event is executed. In the following description, a case in which a valet parking system is adopted in a part or all of a parking lot PA will be described. The parking lot PA in the scene shown in FIG. 3 is an example of a vast parking lot having eight parking areas (parking areas Pa1 to Pa8 hereinafter referred to as parking areas Pa when they are not distinguished). The parking lot PA in the scene shown in FIG. 3 is assumed to be mainly used by vehicles having automated driving level 4 or higher among automated driving levels classified as follows.

Here, the automated driving level refers to, for example, a level according to a degree of driving control in a vehicle system such as a level at which all driving control is automatedly performed in the vehicle, a level at which driving control such as acceleration/deceleration or steering is automatedly performed, or the like. Automated driving level 4 is a level at which all driving control in situations including emergency situations can be delegated to the vehicle system without requiring intervention of the driver such as monitoring of a traveling state of a vehicle of a driver (i.e., the driver's duty of care) or an operation on the driving operator in at least a specific place (here, the parking lot PA). Although automated driving level 3 has a lower degree of driving control than automated driving level 4 and allows a lower duty of care to be imposed on the driver, automated driving level 3 is a level at which all driving control can be delegated to the vehicle system under a fixed condition (for example, a case in which the vehicle travels on a congested road at a fixed speed or the like). Although automated driving level 2 has a lower degree of driving control than automated driving level 3 and allows a higher duty of care to be imposed on the driver than the automated driving level 3, automated driving level 2 is a level at which driving control of at least one of acceleration/deceleration and steering of the vehicle can be delegated to the vehicle system without performing an operation on the driving operator. Automated driving level 1 is a level at which only a specific function (for example, an inter-vehicle distance keeping function) in, for example, a driving assistance device represented by an adaptive cruise control system (ACC) and a lane keeping assistance system (LKAS), can be delegated to the vehicle system and the driver performs most control for causing the vehicle to travel, i.e., control of driving assistance is performed by the vehicle system instead of automated driving. Automated driving level 1 or lower (for example, automated driving level 0) is a level of manual driving in which the vehicle system does not perform control related to driving control. In the following description, automated driving level 1 and automated driving level 2 are similar to manual driving, i.e., automated driving level 3 or higher is assumed to be a level of automated driving. It is assumed that each vehicle recognizes its own automated driving level.

The user U (occupant) of the vehicle M selects whether to enter a valet parking type parking lot or a manual parking type parking lot before the parking lot is used. When the vehicle M enters the manual parking type parking lot, the user U is in the vehicle M until he/she reaches a parking space PS within a specific parking area Pa (for example, the parking area Pa8). Here, the specific parking area Pa may be a parking area Pa disposed to be dedicated to a vehicle that is not automatedly driven. When the vehicle M leaves the manual parking type parking lot, the user U causes the vehicle M to depart from the parking lot after independently moving to the parking space PS and getting into the vehicle M.

On the other hand, when the vehicle M enters the valet parking type parking lot, the user U may cause the vehicle M to be stopped at any dedicated position (any one of stopping areas 311 to 314 which are hereinafter referred to as stopping areas 310 when they are not distinguished) arranged within the parking lot PA and gets out of the vehicle M using a getting-into/out area adjacent to the stopping area 310 (any one of getting-into/out areas 321 to 324 which are hereinafter referred to as getting-into/out areas 320 when they are not distinguished). The user U getting out of the vehicle M in any one getting-into/out area 320 goes from a position in the getting-into/out area 320 where he/she has got out of the vehicle M to a visiting destination facility. At this time, the user U may walk, for example, on the sidewalk within the parking lot PA toward the visiting destination facility or may go to the visiting destination facility while getting on, for example, a bus (a so-called pick-up/drop-off bus) which circulates within the parking lot PA or around the parking lot PA. A method of parking (entering) of the vehicle M after the user U gets out of the vehicle M in the valet parking type parking lot will be described below.

When the vehicle M has entered the valet parking type parking lot, the user U gets into the vehicle M using any one getting-into/out area 320 as in the case when the user U gets out of the vehicle M. The getting-into/out area 320 where the user U gets into the vehicle M is designated by the parking lot management device 400. Thus, the user U goes from the visiting destination facility to any one getting-into/out area 320 designated by the parking lot management device 400. At this time, the user U may walk toward the designated getting-into/out area 320 on foot or go to the designated getting-into/out area 320, for example, after getting on the pick-up/drop-off bus.

A combination of each stopping area 310 and a getting-into/out area 320 corresponding thereto is an example of each “platform”. In the following description, a platform which is a combination of the stopping area 311 and the getting-into/out area 321 is set as a first platform, a platform which is a combination of the stopping area 312 and the getting-into/out area 322 is set as a second platform, a platform which is a combination of the stopping area 313 and the getting-into/out area 323 is set as a third platform, and a platform which is a combination of the stopping area 314 and the getting-into/out area 324 is set as a fourth platform.

A first gate including a gate 301-in and a gate 301-out is provided on a route from a road Rd1 shown in FIG. 3 to the visiting destination facility. A second gate including a gate 302-in and a gate 302-out is provided on a route from a road Rd2 intersecting the road Rd1 at an intersection Crd shown in FIG. 3 to the visiting destination facility. When the first gate and the second gate are not distinguished, they are referred to as a gate 300-in and a gate 300-out or gates 300. When the road Rd1 and the road Rd2 are not distinguished, they are referred to as roads Rd. The vehicle M moves to the stopping area 310 through the gate 300-in according to manual driving or automated driving. Each stopping area 310 faces a corresponding getting-into/out area 320. Each getting-into/out area 320 is provided with eaves for avoiding rain and snow.

The getting-into/out area 320 may have a dedicated getting-into area and a dedicated getting-out area or the dedicated getting-into area and the dedicated getting-out area may be changed according to the presence/absence and the number of users who desire to use the getting-into/out area 320. In the following description, a case in which a fixed dedicated getting-into area and a fixed dedicated getting-out area are not particularly provided in the getting-into/out area 320 and are shared by a user who gets into the vehicle and a user who gets out of the vehicle will be described. As shown in FIG. 3, cameras (cameras C1 to C4) for imaging (monitoring) the stopping areas 310 are provided. In the parking lot PA, cameras such as a camera (not shown) for imaging (monitoring) a situation of each moving route for the vehicle to move in the parking lot PA, a camera (not shown) for imaging (monitoring) a situation within each parking area Pa, and a camera (not shown) for imaging (monitoring) a situation of each gate 300-out are provided at various positions. The cameras are referred to as cameras C when they are not distinguished. The camera C is, for example, a digital camera using a solid-state imaging device such as a CCD or a CMOS, and transmits periodically captured images to the parking lot management device 400. The parking lot management device 400 uses the images periodically transmitted by the cameras C as information for identifying a degree of congestion of each platform, a moving route, or the parking area Pa, i.e., a congestion situation of vehicles or users of vehicles within the parking lot PA. The camera C is an example of a means for obtaining “information associated with a parking lot”.

After the user gets out of the vehicle M in the stopping area 310, the vehicle M performs automated driving in an unmanned manner and starts an autonomous parking event in which the vehicle M moves to the parking space PS within the parking lot PA. A start trigger of the autonomous parking event may be, for example, any operation of the user or may be a predetermined signal wirelessly received from the parking lot management device 400. When the autonomous parking event starts, the autonomous parking controller 142 controls the communication device 20 so that the communication device 20 transmits a parking request to the parking lot management device 400. The vehicle M moves from the stopping area 310 to the parking lot PA in accordance with the guidance of the parking lot management device 400 or while performing sensing on its own.

As described above, the parking lot PA is assumed to be used mainly by vehicles having automated driving level 4 or higher. Thus, when the automated driving level of the vehicle entering the valet parking type parking lot is higher than or equal to automated driving level 4, the parking lot management device 400 guides the vehicle so that the vehicle is allowed to be parked in the parking space PS within any one parking lot Pa according to automated driving based on a remote operation. On the other hand, when the automated driving level of the vehicle entering the valet parking type parking lot is lower than automated driving level 4, i.e., when the automated driving level is 3, the parking lot management device 400 guides the vehicle so that the vehicle is parked in the parking space PS within the parking area Pa (for example, the parking area Pa1) in the vicinity of a specific platform (for example, the first platform) without setting a target vehicle for which a process of selecting a platform where a user of the vehicle gets into the vehicle to be described below is executed. Here, the specific platform is, for example, a platform having a lower degree of difficulty of traveling than other platforms when the vehicle is allowed to enter the parking space PS and when the vehicle is allowed to leave the parking space PS according to automated driving due to a simple moving route from the platform to the parking space PS, a wide road width of the moving route, and the like.

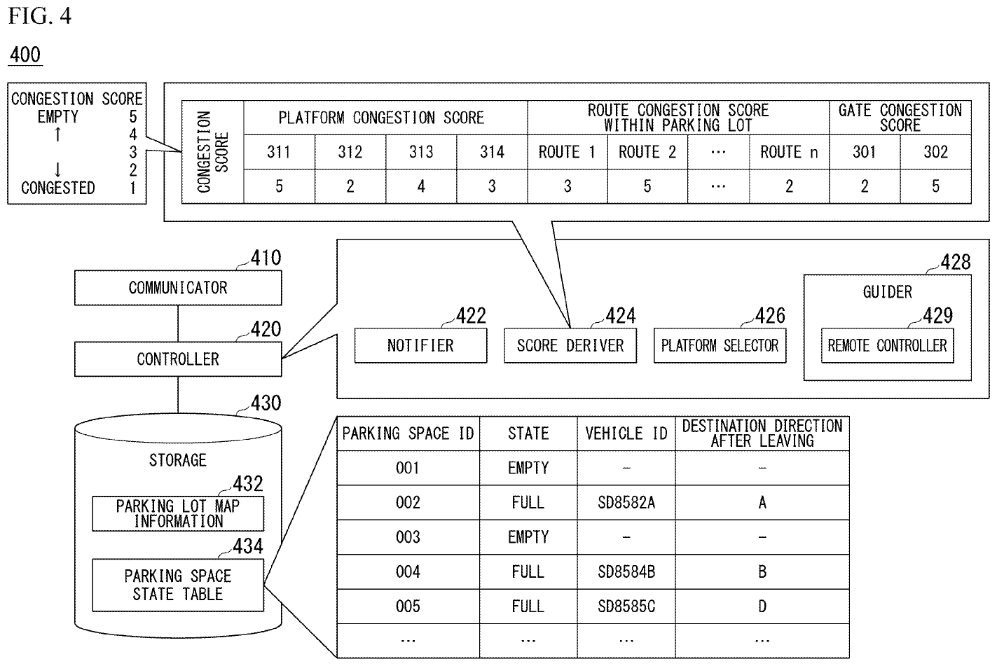

FIG. 4 is a diagram showing an example of a configuration of the parking lot management device 400 according to the first embodiment. The parking lot management device 400 includes, for example, a communicator 410, a controller 420, and a storage 430. The controller 420 includes, for example, a notifier 422, a score deriver 424, a platform selector 426, and a guider 428. The guider 428 includes, for example, a remote controller 429. The storage 430 stores information such as parking lot map information 432 and a parking space state table 434.

The communicator 410 wirelessly communicates with the vehicle M, other vehicles, various types of server devices, or the user terminal T. The communicator 410 receives images periodically transmitted by the camera C. The controller 420 guides the vehicle to the parking space PS on the basis of the information and the images acquired by the communicator 410 and the information stored in the storage 430. The parking lot map information 432 is information geometrically indicating a structure of the parking lot PA. The parking lot map information 432 includes coordinates for each parking space PS. In the parking space state table 434, for example, a state which is an empty state or a full (parked) state, a vehicle ID which is identification information of a vehicle during parking in the case of the full state, and information of a destination direction after leaving which is information of a traveling direction of the vehicle after the vehicle leaves the parking lot PA are associated with a parking space ID which is identification information of the parking space PS. Here, the information of the destination direction after leaving recorded in the parking space state table 434 is referred to in a process of selecting a platform where the user U gets into the vehicle (i.e., determining the stopping area 310 to which the leaving vehicle M is automatedly moved and headed) to be executed by the controller 420 when leaving of the vehicle M is requested by the user U. The parking space state table 434 is an example of “information associated with a parking lot” in the claims.

FIG. 4 shows an example of a case in which information of the destination direction after the vehicle parked at the parking space ID=002 leaves is a “direction A” shown in FIG. 3, information of the destination direction after the vehicle parked at the parking space ID=004 leaves is a “direction B” shown in FIG. 3, and information of the destination direction after the vehicle parked at the parking space ID=005 leaves is a “direction D” shown in FIG. 3.

The information of the destination direction after leaving is transmitted by an application used for entering the parking lot PA or leaving the parking lot PA (hereinafter referred to as a parking lot application) to be executed by the user terminal T of the user U or the like to the parking lot management device 400 directly or via a server device that manages the parking lot management device 400 when the user U is in the visiting destination facility (when the vehicle M enters the parking lot PA or the vehicle M leaves the parking lot PA). In the parking lot management device 400, the communicator 410 receives the information of the destination direction after leaving transmitted by the parking lot application and the information of the destination direction after leaving received by the controller 420 (more specifically, the notifier 422 to be described below) is received and recorded in the parking space state table 434.

The information of the destination direction after leaving is not necessarily indispensable information. That is, when the information of the destination direction after leaving is not recorded in the parking space state table 434, the controller 420 can execute a process of selecting a platform where the user U gets into the vehicle without referring to the information of the destination direction after leaving.

When the communicator 410 receives a parking request from the user terminal T or the vehicle of the user U, the controller 420 extracts a parking space PS whose state is empty with reference to the parking space state table 434, acquires a position of the extracted parking space PS from the parking lot map information 432, and transmits a suitable route to the acquired position of the parking space PS to the vehicle using the communicator 410. The controller 420 may recognize a congestion situation of vehicles within the parking lot PA on the basis of images periodically received from the camera C by the communicator 410 and transmit a suitable route for more smoothly moving the vehicle to a position of the extracted parking space PS to the vehicle. The controller 420 instructs a specific vehicle to stop or slow down, as necessary, on the basis of a positional relationship of a plurality of vehicles so that the vehicles do not move to the same position at the same time.

In the vehicle receiving the route (hereinafter, referred to as the vehicle M), the autonomous parking controller 142 generates a target trajectory based on the route. When the vehicle M approaches the target parking space PS, the parking space recognizer 132 recognizes parking slot lines that partition the parking space PS and the like, recognizes a detailed position of the parking space PS, and provides the recognized position to the autonomous parking controller 142. The autonomous parking controller 142 receives the provided position to correct the target trajectory and cause the vehicle M to be parked in the parking space PS.

### [Autonomous Parking Event-Time of Leaving]

The autonomous parking controller 142 and the communication device 20 maintain the operating state also when the vehicle M has been parked. For example, when a leaving instruction transmitted by the parking lot management device 400 has been received in response to the leaving request transmitted by the user's terminal device (the user terminal T), the autonomous parking controller 142 causes the system of the vehicle M to be activated and causes the vehicle M to move to the designated stopping area 310 in accordance with the guidance of the parking lot management device 400. The autonomous parking controller 142 may activate the system of the vehicle M, for example, when the communication device 20 has received a pick-up request from the user's terminal device (the user terminal T), and may cause the vehicle M to move to the designated stopping area 310 in accordance with the guidance of the parking lot management device 400. At this time, the autonomous parking controller 142 controls the communication device 20 so that the communication device 20 transmits a leaving request for requesting the guidance of movement from the parking space PS where the vehicle has currently been parked to any one stopping area 310 to the parking lot management device 400. When the leaving request transmitted by the server device or the parking lot application which is being executed by the user terminal T of the user U, i.e., the user terminal T of the user U or the vehicle M, is received, the parking lot management device 400 selects any one getting-into/out area 320 and guides the vehicle M to the selected getting-into/out area 320. The leaving request is not limited to the leaving request transmitted from the terminal device (the user terminal T) of the user U and may be a leaving request automatedly transmitted by the parking lot management device 400 on the basis of the fact that the user U has passed through a predetermined place, the fact that there is an action from which subsequent leaving can be estimated (payment information in a predetermined store or the like) from the action tendency of the user U, and the like. In the following description, a case in which a parking request is transmitted directly to the parking lot management device 400 by the parking lot application which is being executed by the user terminal T of the user U will be described.

The controller 420 of the parking lot management device 400 instructs a specific vehicle to stop or slow down as necessary so that the vehicles do not move to the same position at the same time on the basis of a positional relationship of a plurality of vehicles as in the entering process. When the vehicle M is moved to the designated stopping area 310 and the user is allowed to get into the vehicle M, the autonomous parking controller 142 causes the vehicle M to move to the designated gate 300-out in accordance with the guidance of the parking lot management device 400. When the vehicle M is moved to the designated gate 300-out, an operation of the autonomous parking controller 142 is stopped and the manual driving or the automated driving by another functional unit is started.

The autonomous parking controller 142 may find an empty parking space on its own on the basis of a detection result of the camera 10, the radar device 12, the finder 14, or the physical object recognition device 16 independently of communication and cause the vehicle M to be parked within the found parking space without being limited to the above description.

The parking lot management device 400 selects the stopping area 310 where the vehicle is moved so that the specific stopping area 310 within the parking lot PA is not congested. That is, the parking lot management device 400 assigns a platform to be used for the user to get into the vehicle parked in the parking lot PA in order to prevent a situation in which users of vehicles are concentrated at a specific platform and leaving of vehicles from the parking lot PA is time-consuming.

As described above, the notifier 422 of the controller 420 receives information of a destination direction after leaving received by the communicator 410 and transmitted by the parking lot application and records the information in the parking space state table 434. The notifier 422 notifies the user U of information of a platform where the user U gets into the vehicle M, i.e., the stopping area 310 to which the leaving vehicle M is automatedly moved and headed, selected by the platform selector 426 to be described below by transmitting the information to the parking lot application. More specifically, the notifier 422 controls the communicator 410 so that the communicator 410 transmits information of the stopping area 310 to which the leaving vehicle M is automatedly moved and headed directly to the user terminal T or to the parking lot application via the server device or the communication device 20 of the vehicle M. Thereby, the user U can know the fact that the vehicle M goes to the platform whose notification is provided by the parking lot application and the user U himself/herself also can move to the platform whose notification is provided and get into the vehicle M at the platform whose notification is provided.

The score deriver 424 of the controller 420 derives a congestion score indicating a congestion situation of vehicles within the parking lot PA and users of the vehicles on the basis of the images periodically received by the communicator 410 from the camera C. More specifically, the score deriver 424 recognizes users while the users are getting into the vehicles in the platforms, users waiting for the vehicles to come to the stopping area 310, and the like on the basis of the images of the stopping areas 310 transmitted by the cameras C1 to C4 and derives a congestion score representing a degree of congestion at each platform (hereinafter, a platform congestion score). For example, the score deriver 424 derives a platform congestion score for each platform on the basis of a ratio between the number of persons of vehicles capable of being accommodated in each platform or the number of vehicles capable of being stopped in the stopping area 310 of each platform and the number of persons (which may be the number of groups) or the number of vehicles imaged in the image. The score deriver 424 recognizes a vehicle which is traveling along each moving route, a vehicle which has been stopped on each moving route, and the like on the basis of an image of each moving route transmitted by the camera C (not shown) for imaging each moving route for the vehicle to move within the parking lot PA and derives a congestion score representing the degree of congestion on each moving route (hereinafter, a route congestion score within the parking lot). For example, the score deriver 424 derives the route congestion score within the parking lot in each moving route on the basis of a ratio between a distance of each moving route (which may be a distance delimited for each section) and the number of vehicles imaged in the image. At this time, the score deriver 424 may recognize whether or not the vehicle is moving, i.e., whether or not the vehicle is passing through or has been stopped on the moving route, on the basis of a plurality of images. The route congestion score within the parking lot may include a congestion score derived by the score deriver 424 recognizing vehicles and the like which have been parked in each parking area Pa or are moving within the parking area Pa on the basis of the image of each parking area Pa transmitted by the camera C (not shown) for imaging the inside of each parking area Pa. The score deriver 424 recognizes vehicles which are waiting to leave each gate 300-out (or which have been stopped) and the like, and derives a congestion score representing a degree of congestion at each gate 300-out (hereinafter, a gate congestion score), on the basis of an image of each gate 300-out transmitted by the camera C (not shown) for imaging each gate 300-out. For example, the score deriver 424 derives a gate congestion score for each gate 300-out on the basis of the number of vehicles lined up toward each gate 300-out imaged in the image. At this time, the score deriver 424 may recognize a vehicle having a small amount of movement as a vehicle lined up toward the gate 300-out.

FIG. 4 shows an example of each congestion score derived by the score deriver 424. In the example of the congestion score shown in FIG. 4, a degree of congestion is represented in five levels, level “1” represents a most congested state, and level “5” represents a least congested state, i.e., an emptiest state.

The score deriver 424 sequentially updates the corresponding congestion score each time an image is sent from each camera C. That is, a current congestion situation of vehicles or users of the vehicles within the parking lot PA is considered in each congestion score. The congestion score is an example of “information associated with a parking lot” in the claims.

When the communicator 410 receives the leaving request transmitted by the parking lot application which is being executed by the user terminal T of the user U of the vehicle M, the platform selector 426 of the controller 420 derives a total score for each platform with reference to the parking space state table 434 and each congestion score. At this time, the platform selector 426 derives the total score for each platform when the leaving vehicle M has passed through a route candidate by designating a route that passes through a least congested (emptiest) moving route among a plurality of moving routes within the parking lot PA through which the leaving vehicle M can pass when going from a current parking position, i.e., the parking space PS, to each platform as the route candidate within the parking lot PA through which the leaving vehicle M passes when going to each platform. The total score for each platform is an example of a “score for each platform” in the claims. The platform selector 426 selects the platform where the user U gets into the vehicle M, i.e., the stopping area 310 to which the leaving vehicle M is automatedly moved and headed, on the basis of the derived total score for each platform.

For example, the platform selector 426 may preferentially select a platform near the gate 300-out where it is easier to perform traveling after leaving such as a platform for enabling the vehicle M to move to the road Rd only by turning left after leaving a suitable gate (the gate 300-out) for the vehicle M to go in the destination direction after leaving recorded in the parking space state table 434, i.e., the gate 300-out closer to the destination direction after leaving. For example, when the vehicle M goes to each platform, the platform selector 426 may preferentially select a platform at which the vehicle M can arrive without passing through a congested area within the parking lot PA, i.e., a congested moving route among the moving routes within the parking lot PA. In other words, the platform selector 426 may preferentially select a platform at which the vehicle M can arrive by passing through an available moving route within the parking lot PA. For example, the platform selector 426 may preferentially select a platform capable of accommodating a large number of users of vehicles. The platform selector 426 may be configured to select one or more platforms installed in the parking lot PA as a platform where the user U gets into the vehicle M and finally select one platform from among the selected platforms.

The platform selector 426 outputs information of the selected platform to the notifier 422. Thereby, the notifier 422 transmits the information of the platform selected by the platform selector 426 to the parking lot application and notifies the user U of the information. The platform selector 426 outputs the information of the selected platform to the guider 428.

The guider 428 of the controller 420 guides the vehicle M to the platform selected by the platform selector 426. At this time, the guider 428 causes the system of the vehicle M to be activated and causes the autonomous parking controller 142 to control the vehicle M so that the vehicle M goes to the platform selected by the platform selector 426. The remote controller 429 of the guider 428 causes the vehicle M to automatedly travel according to a remote operation. The remote controller 429 causes the vehicle M to automatedly travel to the gate 300-out according to a remote operation also after the user U gets into the vehicle M at the platform selected by the platform selector 426. In particular, when a distance between the platform selected by the platform selector 426 and the gate 300-out where the vehicle M leaves is long (the distance is a predetermined reference value or more), the vehicle M is allowed to automatedly travel to the gate 300-out according to a remote operation. Here, the “predetermined reference value” is, for example, a value obtained by predetermining a movement distance of the vehicle M within the parking lot PA, the number of turns of the vehicle M, the number of intersections through which the vehicle M passes on the way, and the like. In this manner, the remote controller 429 remotely operates the vehicle and causes the vehicle to automatedly travel within the parking lot PA.

### [Platform Selection Process]

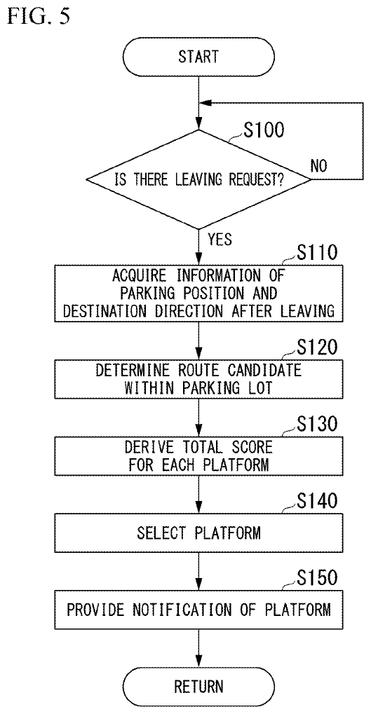

Hereinafter, a process of selecting a platform where the user U gets into the vehicle M (or determining a stopping area 310 to which the leaving vehicle M is automatedly moved and headed) implemented by the platform selector 426 will be described. FIG. 5 is a flowchart showing an example of a flow of the platform selection process to be executed by the platform selector 426 according to the first embodiment. In the following description, it is assumed that the notifier 422 receives information of the destination direction after leaving received by the communicator 410 and transmitted by the parking lot application and records the information in the parking space state table 434. It is assumed that the score deriver 424 derives a congestion score on the basis of each image periodically transmitted by the camera C.

The platform selector 426 checks whether or not there is a leaving request transmitted by the parking lot application (step S100). When the leaving request has not been transmitted by the parking lot application in step S100, the platform selector 426 returns the process to step S100 and iteratively checks the presence or absence of the leaving request transmitted by the parking lot application at predetermined time intervals.

On the other hand, when there is a leaving request transmitted by the parking lot application (hereinafter assumed to be a parking lot application which is being executed by the user terminal T of the user U of the vehicle M) in step S100, the platform selector 426 acquires a parking space ID recorded in the parking space state table 434, i.e., information of a parking position of the vehicle M and a destination direction after leaving (step S110). The platform selector 426 determines a route candidate within the parking lot PA through which the vehicle M passes when the vehicle M goes to each platform disposed in the parking lot PA (step S120).

Subsequently, the platform selector 426 derives a total score for each platform when the vehicle M passes through the determined route candidate and goes to each platform (step S130). Then, the platform selector 426 selects a platform where the user U of the vehicle M gets into the vehicle M on the basis of the derived total score for each platform (step S140). The platform selector 426 outputs information of the platform selected in step S140 to the notifier 422. Thereby, the notifier 422 transmits the information of the platform selected by the platform selector 426 in step S140 to the parking lot application and notifies the user U of the information (step S150).

As described above, the platform selector 426 of the first embodiment selects a platform to which a vehicle allowed to leave in accordance with a currently received leaving request goes according to automated driving by a remote operation on the basis of the parking space state table 434 stored in the storage 430 and the congestion score derived by the score deriver 424 when there is a leaving request for any vehicle. The notifier 422 notifies a user of the vehicle allowed to leave in accordance with the currently received leaving request of information of the platform selected by the platform selector 426. Thereby, the user and the vehicle meet at a position of the platform selected by the platform selector 426 and the user can get into the vehicle. Thus, the parking lot management device 400 of the first embodiment can cause a vehicle to smoothly leave the parking lot PA without concentrating users of vehicles on a specific platform within the parking lot PA.

### Second Embodiment

Hereinafter, a second embodiment will be described. In the second embodiment, a platform selector 426 of a parking lot management device 400 selects a platform where a user gets into a vehicle with a situation of a road around a parking lot PA (hereinafter, a nearby road) (or determines a stopping area 310 to which a leaving vehicle is automatedly moved and headed). Thus, in the second embodiment, information recorded in a parking space state table 434 to be referred to when the platform selector 426 performs a platform selection process and a congestion score derived by a score deriver 424 are different from those of the first embodiment.

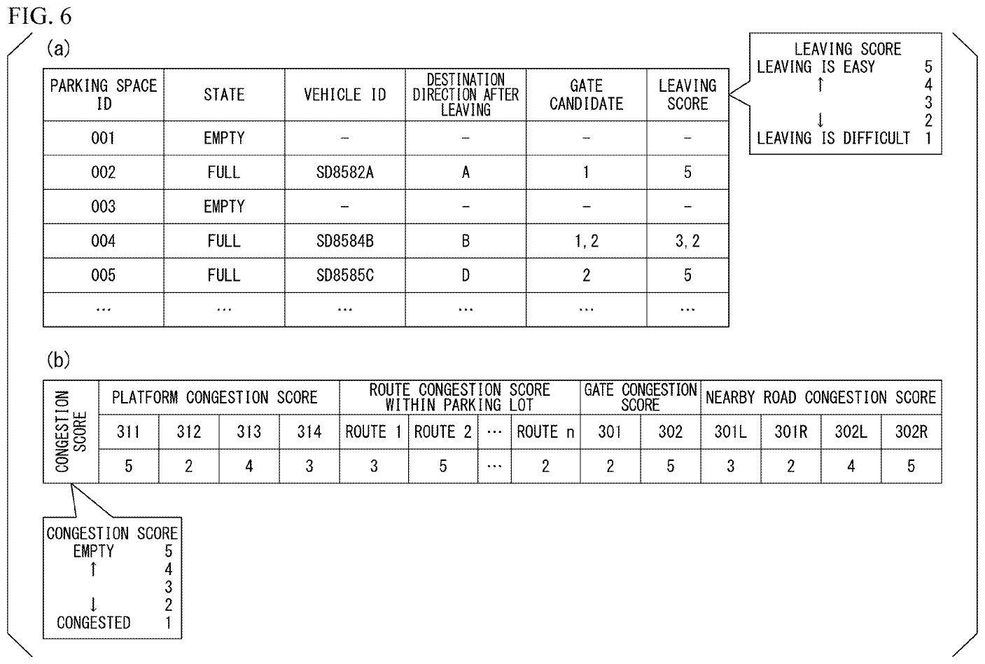

FIG. 6 is a diagram showing an example of the parking space state table 434 and the congestion score derived by the score deriver 424 in the parking lot management device 400 according to the second embodiment. (a) of FIG. 6 shows an example of the parking space state table 434 and (b) of FIG. 6 shows an example of the congestion score.

In the parking space state table 434 shown in (a) of FIG. 6, gate candidate information and a leaving score are added in addition to information recorded in the parking space state table 434 of the first embodiment shown in FIG. 4. The gate candidate information is, for example, information representing a gate (i.e., a gate 300-out) for allowing the vehicle parked in the parking lot PA to be in a direction recorded in information of a destination direction after leaving easily without making a detour. The gate candidate information may be derived by the score deriver 424 on the basis of the information of the destination direction after leaving or the user U may designate a desired gate according to the parking lot application. In (a) of FIG. 6, an example in which a gate 301-out where a vehicle parked at the parking space ID=002 can move to a road Rd1 only by turning left after leaving is recorded as the gate candidate information so that the vehicle is in a “direction A” shown in FIG. 3 which is a destination direction after leaving is shown. An example in which the gate 301-out where a vehicle parked at the parking space ID=004 can move to the road Rd1 only by turning right after leaving is recorded as the gate candidate information so that the vehicle is in a “direction B” shown in FIG. 3 which is a destination direction after leaving is shown. A gate 302-out for enabling the vehicle parked at the parking space ID=004 to enter the road Rd1 in the “direction B” shown in FIG. 3 by turning right after leaving, moving to a road Rd2, and subsequently turning right at an intersection Crd is also recorded as the gate candidate information. An example in which the gate 302-out where a vehicle parked at the parking space ID=005 can move to the road Rd2 only by turning left after leaving is recorded as the gate candidate information so that the vehicle is in a “direction D” shown in FIG. 3 which is a destination direction after leaving is shown.

The leaving score is information indicating a degree of difficulty of traveling when the vehicle leaves the parking lot PA from the gate 300-out and is in a direction recorded in information of the destination direction after leaving. The leaving score may be derived by the score deriver 424 on the basis of information of the destination direction after leaving and information of a gate candidate. In (a) of FIG. 6, an example in which level “5” among five levels is set when the vehicle can move to the road Rd easily only by turning left after leaving, level “3” among the five levels is set when the vehicle can move to the road Rd only by turning right after leaving, and level “2” among the five levels is set in a leaving process in which it is necessary for the vehicle to turn right after leaving and further turn right at the intersection Crd, i.e., when a degree of difficulty of traveling is slightly high (traveling becomes difficult), is shown. In the leaving score, level “1” represents a highest degree of difficulty of traveling and level “5” represents a lowest degree of difficulty of traveling, i.e., easy traveling.

A nearby road congestion score shown in (b) of FIG. 6 is a score in which a degree of congestion of vehicles which travel on a nearby road derived by the score deriver 424 on the basis of an image of the nearby road transmitted by a camera (not shown) (referred to as a camera C when the camera is not distinguished from another camera) for imaging (monitoring) a situation of the nearby road around the parking lot PA is represented in five levels. For example, the score deriver 424 derives a nearby road congestion score for a nearby road to which the vehicle moves by turning left or right after leaving each gate 300-out on the basis of the number of vehicles imaged in the image. At this time, the score deriver 424 may recognize whether or not vehicles are moving on the nearby road, i.e., whether or not the nearby road is congested, on the basis of a plurality of images.

The platform selector 426 of the second embodiment derives a total score for each platform together with information of a gate candidate added to the parking space state table 434 and a leaving score and a nearby road congestion score added to a congestion score and selects a platform where the user U gets into the vehicle M.

### [Platform Selection Process]

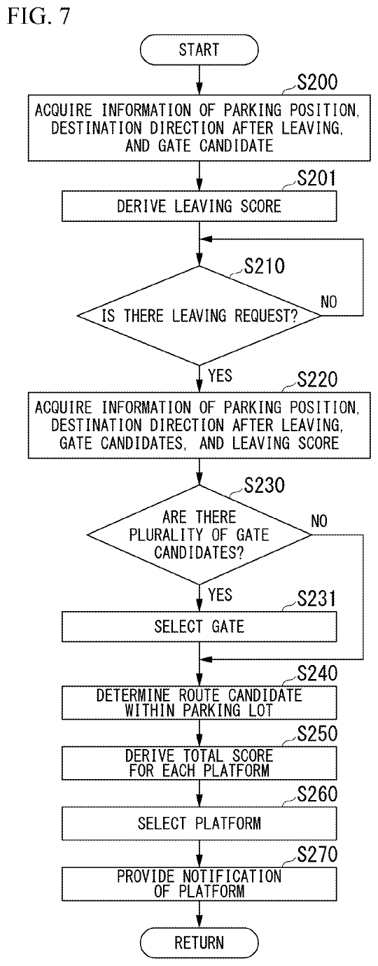

Hereinafter, a process of selecting a platform where the user U gets into the vehicle (or determining a stopping area 310 to which a leaving vehicle M is automatedly moved and headed) implemented by the platform selector 426 of the second embodiment will be described. FIG. 7 is a flowchart showing an example of a flow of a platform selection process to be executed by the platform selector 426 according to the second embodiment. In the following description, it is assumed that gate candidate information is stored in the parking space state table 434 and the score deriver 424 derives a leaving score. It is assumed that the score deriver 424 has already derived the nearby road congestion score simultaneously with the other congestion score on the basis of each image periodically transmitted by the camera C.

When the gate candidate information is recorded in the parking space state table 434, the score deriver 424 acquires information of a parking space ID recorded in the parking space state table 434, i.e., a parking position of the vehicle, and a destination direction after leaving (step S200). The score deriver 424 derives a leaving score and causes the leaving score to be stored in the parking space state table 434 (step S201).

The platform selector 426 checks whether or not there is a leaving request transmitted by the parking lot application (step S210). When the parking request has not been transmitted by the parking lot application in step S210, the platform selector 426 returns the process to step S210 and iteratively checks the presence or absence of the leaving request transmitted by the parking lot application at predetermined time intervals.

On the other hand, when there is a leaving request transmitted by the parking lot application (hereinafter assumed to be a parking lot application which is being executed by the user terminal T of the user U of the vehicle M) in step S210, the platform selector 426 acquires a parking space ID (a parking position of the vehicle M), information of a destination direction after leaving, gate candidate information, and information of a leaving score recorded in the parking space state table 434 (step S220).

The platform selector 426 checks whether or not the acquired gate candidate information includes a plurality of gate candidates (step S230). When it is checked that the gate candidate information does not include a plurality of gate candidates in step S230, the platform selector 426 moves the process to step S240.

On the other hand, when it is checked that the gate candidate information includes a plurality of gate candidates in step S230, the platform selector 426 selects an emptier gate (i.e., the gate 300-out) with reference to the gate congestion score (step S231). The platform selector 426 determines a route candidate within the parking lot PA through which the vehicle M passes when going to each platform disposed in the parking lot PA (step S240).

Subsequently, the platform selector 426 derives a total score for each platform when the vehicle M passes through the determined route candidate and goes to each platform (step S250). Then, the platform selector 426 selects a platform where the user U of the vehicle M gets into the vehicle M on the basis of the derived total score for each platform (step S260). The platform selector 426 outputs information of the platform selected in step S260 to the notifier 422. Thereby, the notifier 422 transmits the information of the platform selected by the platform selector 426 in step S260 to the parking lot application and notifies the user U of the information (step S270).

[Example of Scene in which Vehicle is Allowed to Leave]

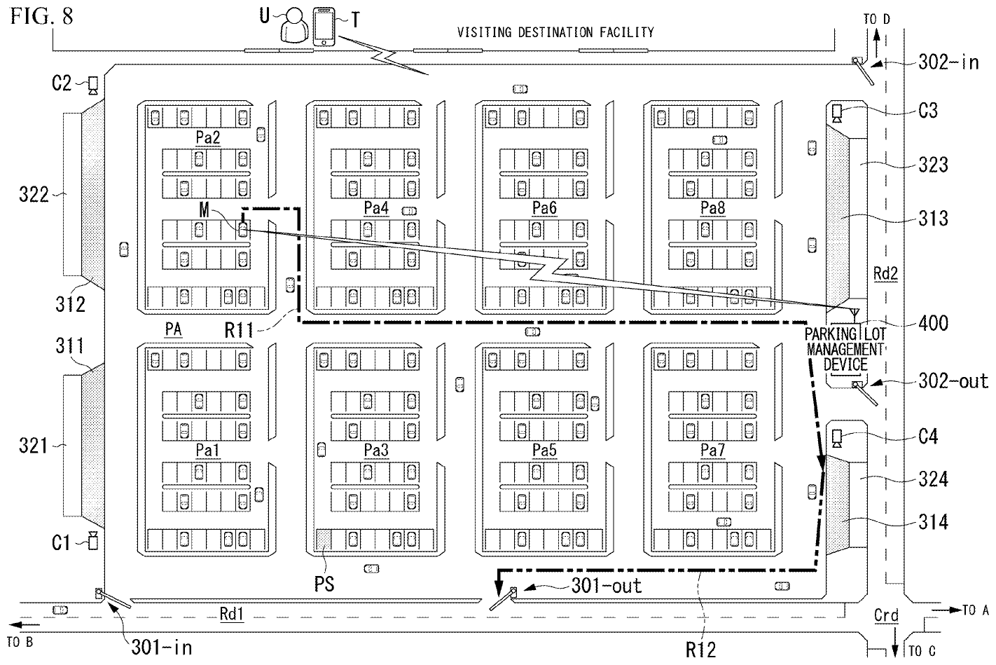

Hereinafter, an example of a moving route selected in the platform selection process of the platform selector 426 will be described with reference to FIGS. 8 to 10. FIG. 8 is a diagram schematically showing a scene of a first example of a moving route selected in the platform selection process of the platform selector 426. In FIG. 8, an example of a moving route along which the parking lot management device 400 causes the vehicle M to automatedly travel according to a remote operation when a vehicle associated with the parking space ID=002 of the parking space state table 434 shown in (a) of FIG. 6 is the vehicle M is shown. It is assumed that the parking space ID=002 indicates a parking space PS within the parking area Pa2, the platform selector 426 selects a fourth platform, and the vehicle M is allowed to leave the gate 301-out. In the scene shown in FIG. 8, the remote controller 429 causes the vehicle M to automatedly travel, for example, to the fourth platform on a moving route R11. After the user U gets into the vehicle M at the fourth platform, the remote controller 429 causes the vehicle M to automatedly travel toward the gate 301-out along a moving route R12. Thereby, after the vehicle M leaves the gate 301-out, the vehicle M can move to the road Rd1 in the direction A only by turning left.

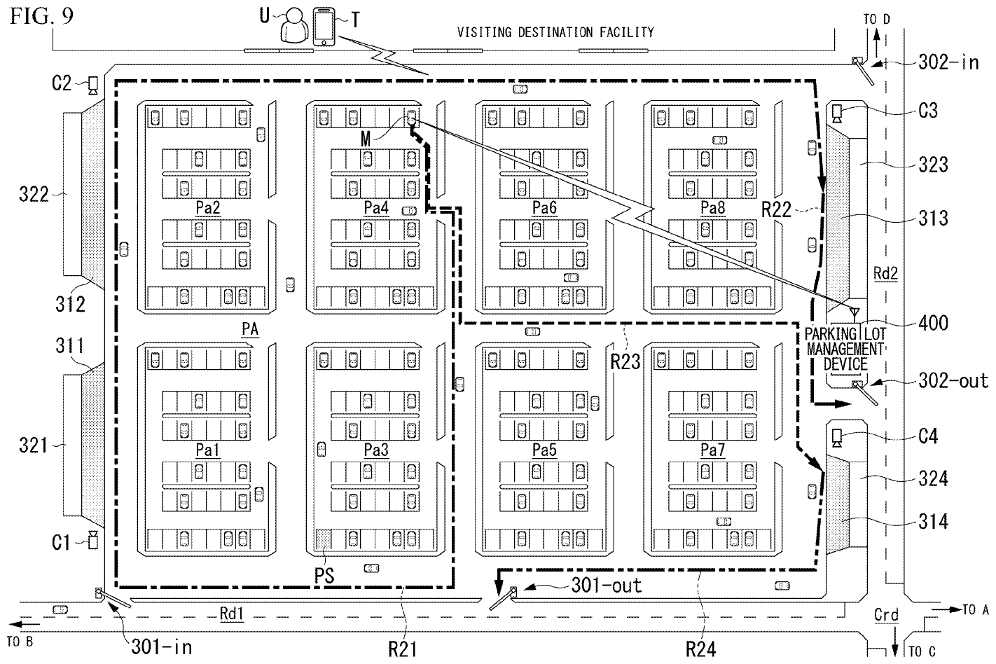

FIG. 9 is a diagram schematically showing a scene of a second example of a moving route selected in the platform selection process of the platform selector 426. In FIG. 9, an example of a moving route along which the parking lot management device 400 causes the vehicle M to automatedly travel according to a remote operation when a vehicle associated with the parking space ID=004 in the parking space state table 434 shown in (a) of FIG. 6 is the vehicle M is shown. It is assumed that the parking space ID=004 indicates a parking space PS within the parking area Pa4, the platform selector 426 selects a third platform, and the vehicle M is allowed to leave the gate 302-out. In the scene shown in FIG. 9, for example, the remote controller 429 causes the vehicle M to automatedly travel toward the third platform on a moving route R21. After the user U gets into the vehicle M at the third platform, the remote controller 429 causes the vehicle M to automatedly travel so that the vehicle M goes to the gate 302-out on a moving route R22. Thereby, the vehicle M turns right after leaving the gate 302-out and subsequently turns right at the intersection Crd, thereby moving to the road Rd1 in the direction B.

In the parking space ID=004 of the parking space state table 434 shown in (a) of FIG. 6, the gate 301-out is also included in the gate candidate information. Thus, for example, the platform selector 426 can select the fourth platform and cause the vehicle M to leave the gate 301-out. In this case, for example, the remote controller 429 may cause the vehicle M to automatedly travel toward the fourth platform on a moving route R23 and may cause the vehicle M to automatedly travel toward the gate 301-out on a moving route R24 after the user U gets into the vehicle M at the fourth platform. However, the nearby road congestion score shown in (b) of FIG. 6 represents that the vehicle M can more easily move to the road Rd because a score of a road 302R for which the vehicle M turns right after leaving the gate 302-out is greater than a score of a road 301R for which the vehicle M turns right after leaving the gate 301-out. A difference between the nearby road congestion scores is caused due to a situation such as traffic congestion occurring in the roads Rd1. Thus, the platform selector 426 selects the third platform where a degree of difficulty of traveling indicated by the leaving score is high because it is also necessary to turn right at the intersection Crd when the vehicle M turns right after leaving the gate 302-out, but it is easier to move to a first road Rd2 and it is easy to leave the gate 302-out where the vehicle M is considered to be able to move to the road Rd1 according to normal traveling as the platform where the user U gets into the vehicle M.

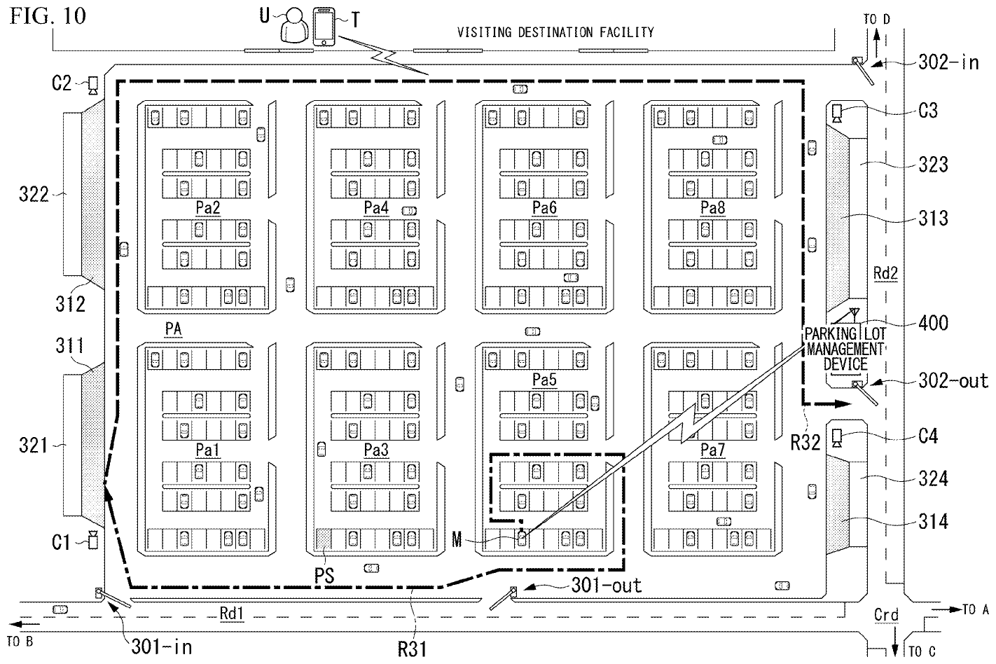

FIG. 10 is a diagram showing a scene schematically showing a third example of the moving route selected in the platform selection process of the platform selector 426. In FIG. 10, an example of a moving route along which the parking lot management device 400 causes the vehicle M to automatedly travel according to a remote operation when a vehicle associated with the parking space ID=005 of the parking space state table 434 shown in (a) of FIG. 6 is the vehicle M is shown. It is assumed that the parking space ID=005 indicates a parking space PS within the parking area Pa5, the platform selector 426 selects a first platform, and the vehicle M is allowed to leave the gate 302-out. In the scene shown in FIG. 10, for example, the remote controller 429 causes the vehicle M to automatedly travel toward the first platform on a moving route R31. After the user U gets into the vehicle M at the first platform, the remote controller 429 causes the vehicle M to automatedly travel so that the vehicle M goes to the gate 302-out on a moving route R32. Thereby, the vehicle M can move to the road Rd2 in the direction D only by turning left after leaving the gate 302-out.

As described above, the platform selector 426 of the second embodiment selects a platform to which a vehicle allowed to leave in accordance with a currently received leaving request goes according to automated driving of a remote operation together with a situation of a nearby road around the parking lot PA on the basis of the parking space state table 434 stored in the storage 430 and the congestion score derived by the score deriver 424 when there is a leaving request for any vehicle. The notifier 422 notifies a user of the vehicle allowed to leave in accordance with the currently received leaving request of information of the platform selected by the platform selector 426. Thereby, the user and the vehicle meet at a position of the platform selected by the platform selector 426 and the user can get into the vehicle. Thus, the parking lot management device 400 of the second embodiment can cause a vehicle to smoothly leave the parking lot PA without concentrating users of vehicles on a specific platform within the parking lot PA.

An example in which one parking lot management device 400 selects a platform to which a vehicle allowed to leave in accordance with a currently received leaving request goes according to automated driving by a remote operation in the parking lot management device 400 of each of the above-described embodiments has been described. However, a case in which all the areas cannot be managed by one parking lot management device 400 in a vast parking lot is also conceivable. In this case, the platform selector 426 of the controller 420 provided in any one parking lot management device 400 among a plurality of parking lot management devices 400 selects a platform to which the user and the vehicle are headed and remote controllers 429 within guiders 428 of controllers 420 provided in the plurality of parking lot management devices 400 may be configured to cooperatively cause the vehicle allowed to leave to automatedly travel according to a remote operation and go to a selected platform and subsequently cause the vehicle to leave the gate 300-out. In this case, an operation similar to the operation in the parking lot management device 400 of each of the above-described embodiments can be conceived. Accordingly, in this case, the description of a process to be executed by the notifier 422, the score deriver 424, the platform selector 426, and the guider 428 (including the remote controller 429) will be omitted.

### [Hardware Configuration]

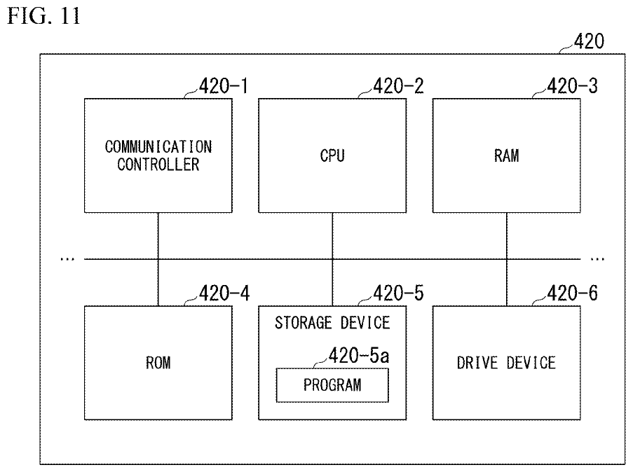

FIG. 11 is a diagram showing an example of a hardware configuration of the controller 420 according to the embodiment. As shown in FIG. 11, the controller 420 has a configuration in which a communication controller 420-1, a CPU 420-2, a random access memory (RAM) 420-3 used as a working memory, a read only memory (ROM) 420-4 storing a boot program and the like, a storage device 420-5 such as a flash memory or a hard disk drive (HDD), a drive device 420-6, and the like are mutually connected by an internal bus or a dedicated communication line. The communication controller 420-1 communicates with components other than the controller 420. The storage device 420-5 stores a program 420-5a to be executed by the CPU 420-2. This program is loaded to the RAM 420-3 by a direct memory access (DMA) controller (not shown) or the like and executed by the CPU 420-2. Thereby, some or all of the notifier 422, the score deriver 424, the platform selector 426, and the guider 428 (including the remote controller 429) are implemented.

The embodiment described above can be represented as follows.

A parking lot management device including:

a storage device storing a program; and

a hardware processor,

wherein the hardware processor executes the program stored in the storage device to:

refer to information associated with a parking lot having a plurality of platforms and select one or more platforms from among the plurality of platforms in response to a leaving request for requesting movement of a vehicle parked in the parking lot from a parking position of the vehicle to the platform.

Although modes for carrying out the present invention have been described using embodiments, the present invention is not limited to the embodiments, and various modifications and substitutions can also be made without departing from the scope and spirit of the present invention.

What is claimed is:

1. A parking lot management device comprising:
a platform selector configured to refer to information associated with a parking lot having a plurality of platforms and select one or more platforms from among the plurality of platforms in response to a leaving request for requesting movement of a vehicle parked in the parking lot from a parking position of the vehicle to the platform.

2. The parking lot management device according to claim 1, further comprising:
a notifier configured to receive information of a traveling direction of a user of the vehicle sending the leaving request after the vehicle leaves the parking lot and notify the user of information of the platform selected by the platform selector.

3. The parking lot management device according to claim 2, further comprising:
a guider configured to guide the vehicle for which the leaving request has been sent to the platform selected by the platform selector.

4. The parking lot management device according to claim 1,
wherein the information associated with the parking lot includes some or all of a degree of congestion for each of the plurality of platforms, the parking position, and the traveling direction after the vehicle leaves the parking lot.

5. The parking lot management device according to claim 1,
wherein the platform selector is configured to derive a score for each of the plurality of platforms on the basis of the information associated with the parking lot and is configured to select one or more platforms from the plurality of platforms on the basis of derived scores.

6. The parking lot management device according to claim 1,
wherein the information associated with the parking lot includes the traveling direction after the vehicle leaves the parking lot, and
wherein the platform selector is configured to preferentially select an appropriate platform near a gate in the traveling direction.

7. The parking lot management device according to claim 1,
wherein the information associated with the parking lot includes a congestion situation of a nearby road around the parking lot, and
wherein the platform selector is configured to select one or more platforms from the plurality of platforms on the basis of a congestion situation of a road to which the vehicle moves after the vehicle leaves the parking lot.

8. The parking lot management device according to claim 1,
wherein the platform selector is configured to preferentially select a platform at which the vehicle is able to arrive without passing through a congested area within the parking lot.

9. The parking lot management device according to claim 8,
wherein the platform selector sets a least congested moving route among a plurality of moving routes from the parking position to the platform as a moving route toward the platform.

10. The parking lot management device according to claim 1,
wherein the platform selector is configured to preferentially select a platform where a large number of users of vehicles parked in the parking lot are able to be accommodated.

11. The parking lot management device according to claim 3,
wherein the guider further comprises a remote controller configured to cause the vehicle within the parking lot to automatedly travel according to a remote operation, and
wherein the remote controller is configured to cause the vehicle which leaves the parking lot to automatedly travel to the gate according to a remote operation in a case where a distance of a predetermined reference value or more is between the platform selected by the platform selector and a gate for the vehicle.

12. The parking lot management device according to claim 3,
wherein the guider is configured to cause a vehicle having a low automated driving level to be parked in a parking area near a specific platform.

13. The parking lot management device according to claim 12,
wherein the specific platform is a platform having a lower degree of difficulty of traveling than other platforms in a case where the vehicle moves around.

14. A parking lot management method using a computer comprising:
referring to information associated with a parking lot having a plurality of platforms and selecting one or more platforms from among the plurality of platforms in response to a leaving request for requesting movement of a vehicle parked in the parking lot from a parking position of the vehicle to the platform.

15. A computer-readable non-transitory storage medium storing a program for causing a computer of a parking lot management device to:
refer to information associated with a parking lot having a plurality of platforms and select one or more platforms from among the plurality of platforms in response to a leaving request for requesting movement of a vehicle parked in the parking lot from a parking position of the vehicle to the platform.
